(19) United States
(12) Patent Application Publication
(10) Pub. No.: US 2005/0065841 A1
(43) Pub. Date: Mar. 24, 2005

(54) Method for assessing information technology needs in a business

(75) Inventor: Graeme R. Middleton, Milton Keynes (GB)

Correspondence Address: BAKER BOTTS L.L.P., 2001 ROSS AVENUE, 6TH FLOOR, DALLAS, TX, 75201, US

(73) Assignee: Electronic Data Systems Corporation

(21) Appl. No.: 10/666,094

(22) Filed: Sep. 19, 2003

(51) Int. Cl. G06F 17/60

(52) U.S. Cl. 705/11

(57) ABSTRACT

A strategic value model provides an ability to evaluate the feasibility of implementing an information technology initiative. The flow process begins by gathering information associated with the operation of the business in categories pertaining to the information technology initiative desired to be implemented. Strategic value ratings are applied to each criteria in the categories. The initiatives are categorized so that like initiatives are assessed against each other. A determination is made to identify which initiatives are to be funded in accordance with the applied strategic value ratings. Funding can then be established for an initiative based on this determination.

### TECHNICAL FIELD OF THE INVENTION

The present invention relates in general to business operations and policy and more particularly to a method for assessing information technology needs in a business.

### BACKGROUND OF THE INVENTION

The most prevalent method previously used to determine the investment of Information Technology to resolve business problems and provide business savings is the Net Present Value (NPV) assessment. This is determined by assembling the cost of the Information Technology activity (normally termed an Initiative or Program) and the predicted savings generated by such an activity. The cost calculations include a net pre-tax cash flow, a cumulative cash flow, a pre-tax net present value, a net present value, and a payback period. The net pre-tax cash flow identifies on a year by year basis the point at which requested funding will be depleted and the impact of the savings on the information technology spending. The cumulative cash flow provides a clearer financial view of the effect of the savings on the investment as the net pre-tax cash flow increases each year. The pre-tax net present value is the same as the investment and is similar to investing money in a bank that gives interest each year. The net present value is an interest that grows exponentially on a year by year basis and totaling the yearly results from the pre-tax net present value. The payback period is normally expressed in months with the shorter the timeframe the quicker the realization of the return on the investment.

The Net Present Value assessment provides various negative aspects in identifying whether an investment in Information technology is worthwhile. This assessment is money only oriented and may not consider the full costs of the activity as it takes into account only what the Initiative will cost and not the cost of the full impact on the business. The assessment only considers build and deployment costs while using unsubstantiated operational costs and unfounded savings or benefits. There is no acknowledgment of savings in the business. A lack of both knowledge and acceptance of the savings in the business is typically generated with no affirmation by those receiving the claimed savings. There are also no assessment categories for various activities of the initiative. Activities are not grouped for assessment purposes with inaccurate data resulting as every activity is compared with each other. Therefore, it is desirable to have an accurate assessment that enables business leaders to make appropriate decisions regarding investments in Information technology for the business.

### SUMMARY OF THE INVENTION

From the foregoing, it may be appreciated by those skilled in the art that a need has arisen for a structured, all-encompassing, and value added approach for driving business decisions regarding the funding of Information Technology activities that will generate greater value to the business. In accordance with the present invention, a method for assessing information technology needs in a business is provided that substantially eliminates or greatly reduces disadvantages and problems associated with conventional assessment techniques.

According to an embodiment of the present invention, there is provided a method for assessing information technology needs in a business that includes gathering information associated with the operation of the business and the activities pertaining to the information technology initiative desired to be implemented, applying strategic value ratings to the activities, categorizing the activities so that like activities are assessed against each other, and determining which activities are to be invested in according to assigned strategic value ratings.

The present invention provides various technical advantages over conventional assessment techniques. Some of these technical advantages are shown and described in the description of the present invention. Embodiments of the present invention may enjoy some, all, or none of these technical advantages. Other technical advantages may be readily ascertainable by those skilled in the art from the following figures, description, and claims.

### BRIEF DESCRIPTION OF THE DRAWINGS

For a more complete understanding of the present invention and the advantages thereof, reference is now made to the following description, taken in conjunction with the accompanying drawings, wherein like reference numerals represent like parts, in which:

FIG. 1 illustrates a simplified diagram of a strategic value model;

FIG. 2 illustrates a simplified diagram of a strategic positioning category of the strategic value model;

FIG. 3 illustrates a simplified diagram of a financial impact category of the strategic value model;

FIG. 4 illustrates a simplified diagram of an intellectual assets category of the strategic value model;

FIG. 5 illustrates a simplified diagram of a business drivers category of the strategic value model;

FIG. 6 illustrates a simplified diagram of a technical impact overlay of the strategic value model;

FIG. 7 illustrates a simplified diagram of a risk impact overlay of the strategic value model.

FIG. 8 illustrates a flow process for the strategic value model.

### DETAILED DESCRIPTION OF THE INVENTION

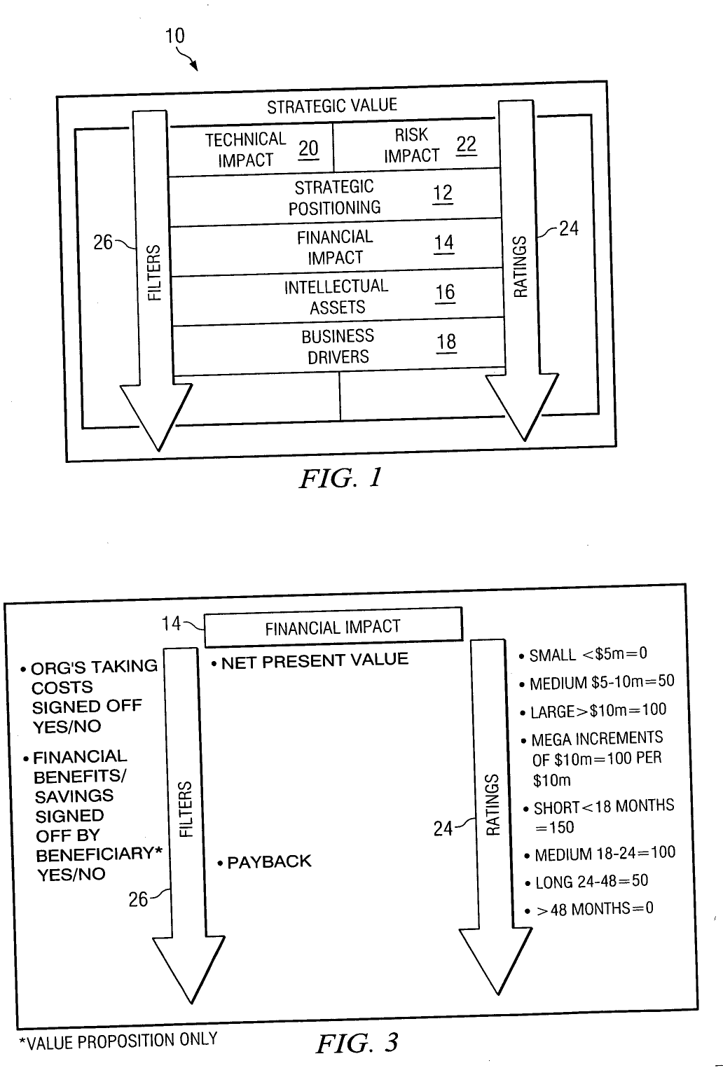

FIG. 1 is a simplified diagram of a strategic value model 10. Strategic value model 10 provides an ability to assess new and existing initiatives related to the information technology strategy for a business. The objective of strategic value model 10 is to provide a decision tool for business operating mechanisms in making recommendations and decisions on whether to support certain initiatives and release or redirect funds based on factors over and above a pure financial view.

Strategic value model 10 includes key categories of measurement and overlaying measurements. The key categories of measurement include strategic positioning 12, financial impact 14, intellectual assets 16, and business drivers 18. The categories of overlay measurement include technical impact 20 and risk impact 22. Ratings 24 and filters 26 are then applied within strategic value model 10.

Strategic positioning 12 determines how an initiative aligns to key areas of strategy. Financial impact 14 assesses the net present value (NPV) and payback of an initiative. This information is generated through a cost and benefit template. The cost and benefit template is designed to capture full costs and total benefits data, both financial and non-financial, from all information technology initiatives, regardless of the life cycle phase it is in (e.g. explore, define, design, etc.). Summary data, such as the results of costs, savings, cash flow, net present value (NPV), payback, and profit and loss impact, is then provided to strategic value model 10 which is essential for the financial and intellectual aspects of the process. Intellectual assets 16, or non-financial benefits, are driven from a cost and benefit model and help align to invisible balance sheet aspects such as human capital (employee satisfaction), structural capital (intellectual property assets), and external capital (client satisfaction). Business Drivers 18 capture events such as alignment to investment plan, alignment to an Enterprise Process Model (EPM), sustainment of business, contractual agreements, legal commitments, and alignment with merger/acquisition targets. Technical impact 20 assesses whether an initiative is in line with technology strategy, uses approved vendors, and is infrastructure compliant. Risk impact 22 provides a further overlay by understanding events such as implementation complexity and insuring an initiative is meeting and achieving its goals. Ratings 24 effectively provide weighting for priority and scoring within strategic value model 10. Filters 26 ensure that required sign off and approval have been obtained.

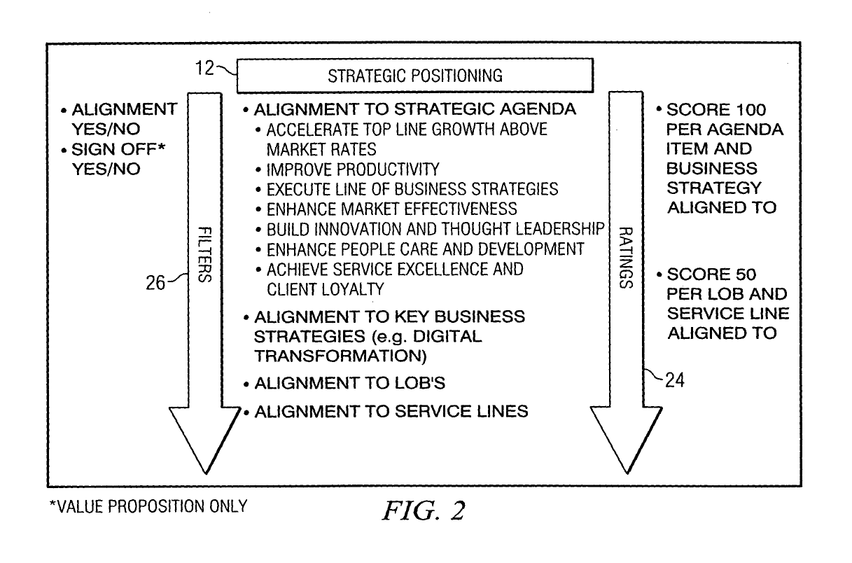

FIG. 2 is a simplified diagram of strategic positioning 12. An important aspect of strategic positioning 12 is in the alignment of all initiatives to business strategies so that the initiatives are supporting or enabling the key focus for the future of the business. An initiative can be aligned to such business strategies as corporate strategic agenda, line of business strategies, service line and service offering strategies, and information technology strategies. Focus is also given to any geography, region, or country that the business considers important for growth.

During an explore or concept review phase of the initiative, an assessment is made as to how the initiative relates to the business strategies. The activities of the initiative are reviewed as part of an operating mechanism support function by corporate strategy and planning and portfolio management to ensure that each activity is correctly aligned with strategic positioning 12 and there is no duplication. During the propose or value proposition review phase, an initiative is signed off by the relevant owner of the initiative. This will ensure that the business is aware of the initiative, can support its activities, provide a report of the progress and impact of the initiative. If signoff is not obtained, then no rating is applied to this category of strategic value model 10. During remaining phases of the initiative, a self assessment is performed to monitor any changes in alignment and, if so, re-engage the operating mechanism support function to capture the changes. Additionally, the operating mechanism may request initiative review for proper strategic positioning alignment to ensure that the initiative is still within the boundaries of the business direction. If it is not, funding may be ceased or reduced for the initiative. Therefore, it is in the best interests of the initiative to verify that all activities are valid at all times.

FIG. 3 is a simplified diagram of financial impact 14. Conventionally, financial impact 14 has been basically the single focus for approving an initiative as it specified the cost and the return for the initiative. Though the present invention is based on the overall value of an initiative, financial impact 14 still remains an important part of the overall value. Financial impact 14 affects an initiative through net present value (NPV) and payback. NPV is driven by the cost and benefit template and takes into account the pre-tax cash flow of an initiative. The pre-tax cash flow is savings plus capital costs plus ongoing non-capital costs which is exponentially grown on a yearly basis over a maximum five year period by a desired percent. Initiatives with negative NPVs are those worthy of consideration. The larger the negative NPV, the better return on investment for the business. Payback is also driven by the cost and benefit template. Payback looks at the cumulative cash flow of an initiative and determines in months when an initiative stops consuming expenses and starts making savings. The cumulative cash flow is the previous year's cumulative cash flow plus the current year's pre-tax cash flow. The quicker the payback period, the quicker savings are made.

During the explore or concept review phase of the initiative, financial impact 14 is not assessed as it is unlikely an initiative will be able to determine to enough degree of accuracy its costs and financial benefits. Any initiative claiming NPV or payback at this stage is likely to have done so under false pretences or performed unauthorized work by going further down the life cycle of the initiative than given the funding for the initiative. Financial impact 14 starts to be evident during the propose or value proposition review phase where an initiative will need to obtain sign off from the relevant business entities providing the funding and the beneficiaries where the savings will come from. This will ensure that the business is aware of the cost for the initiative and make certain that no beneficiaries receive a budgetary surprise further down the line. If funding or benefits are not signed off, then escalation will be made to the operating mechanism. During the remaining phases of the initiative, a self assessment is performed to identify any changes to financial impact 14 and, if so, re-engage the operating mechanism support function to capture the changes. Additionally, the operating mechanism may request review of the initiative for proper financial impact assessment to ensure that it is still financially sound to pursue the initiative. If it is not, funding may be ceased or reduced. It is to the best interests of the initiative that costs, benefits, actuals, and outlooks are kept up to date, reported on the relevant templates, and published in a periodic manner.

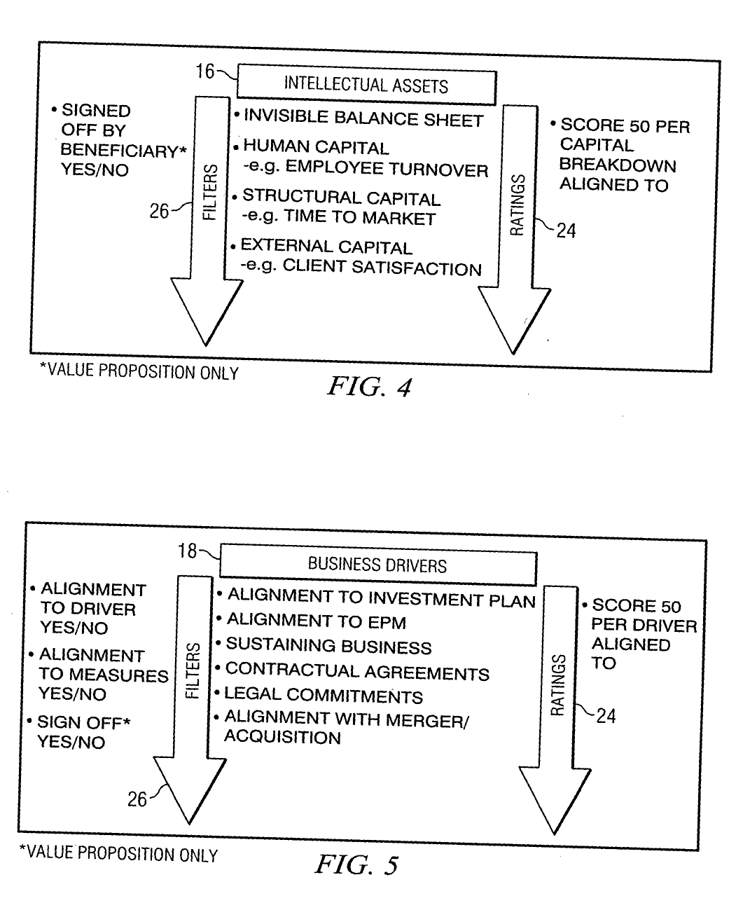

FIG. 4 is a simplified diagram of intellectual assets 16. Intellectual assets 16, or non-financial benefits, are important factors in determining value for an initiative as they support cornerstone principles of profitable growth, collaboration, service excellence, and continuous productivity improvement. Intellectual assets 16 affect the initiative through human capital, structural capital, and external capital. Intellectual assets 16 is driven by the cost and benefit template and takes into account the most common assets of the three capital aspects.

During the explore or concept review phase of the initiative, an assessment is made as to how the initiative relates to intellectual assets 16. Portfolio management performs a check on the activities of the initiative as part of the operating mechanism support function to ensure they are correctly aligned with intellectual assets 16 and there is no duplication. During the propose or value proposition review phase of the initiative, sign off of the initiative from the relevant business entities and beneficiaries occurs. This will ensure that the business is aware of the initiative, can support its activities, and report the progress and impact of the initiative. During the remaining phases of the initiative, a self assessment is performed as to whether there are any changes to intellectual assets 16 and, if so, re-engage the operating mechanism support function to capture the changes. Additionally, the operating mechanism may request review of the initiative to ensure that intellectual asset alignment is still within the boundaries of the direction of the business. If it is not, funding may be ceased or reduced. It is therefore in the interest of the initiative to ensure that the cost and benefit template is updated, periodically published, and intellectual assets 16 are accurate to ensure the validity of initiative activities at all times.

FIG. 5 is a simplified diagram of business drivers 18. Business drivers 18 may be viewed as imperative aspects of the business. It is important that all initiatives and associated activities are aligned with business drivers 18 to ensure that they are supporting or enabling the key focus for the future of the business. An initiative can align to business drivers 18 through alignment to investment plan, alignment to an enterprise process model, sustainment of business, contractual agreements and obligations, legal commitments, and alignment with merger and acquisition targets. In addition, focus is given to factors that align with an Information Technology plan for the business.

During the explore or concept review phase of the initiative, an assessment is made as to how the initiative relates to business drivers 18. Portfolio management performs a check on the activities of the initiative to ensure that they are correctly aligned to business drivers 18 and there is no duplication. During the propose or value proposition review phase of the initiative, sign off from the relevant entity occurs. This will ensure that the fundamental business drivers 18 are understood by the business so that the activities of the initiative are supported and correctly aligned. If sign off is not obtained, then no rating is applied to this category. During the remaining phases of the initiative, a self assessment is performed to determine whether there are any changes to business drivers 18 and, if so, re-engage the operating mechanism support function to capture the changes. Additionally, the operating mechanism may request review of an initiative from a business driver alignment perspective to ensure that it is still within the boundaries of the direction for the business. If it is not, then funding may be ceased or reduced. It is therefore in the best interest of the initiative to ensure that all activities of the initiative are valid with respect to business drivers 18.

An example of the creation of an information technology plan can be found in co-pending U.S. application Ser. No. 09/378,514 and co-pending U.S. application Ser. No. 10/606,661 which are hereby incorporated herein by reference. Strategic value model 10 can complement the creation of an information technology plan by pulling all of the business strategies, drivers, and technical requirements together to clarify things for the business executive. Strategic value model 10 puts into context what the costs will be of achieving the desired outcome, what financial benefits will be received, what intellectual capital gains will be made, and the risk factors involved. This will provide the business executive with the information in a quantitative manner in order to prioritize information technology initiatives to support the needs of the business.

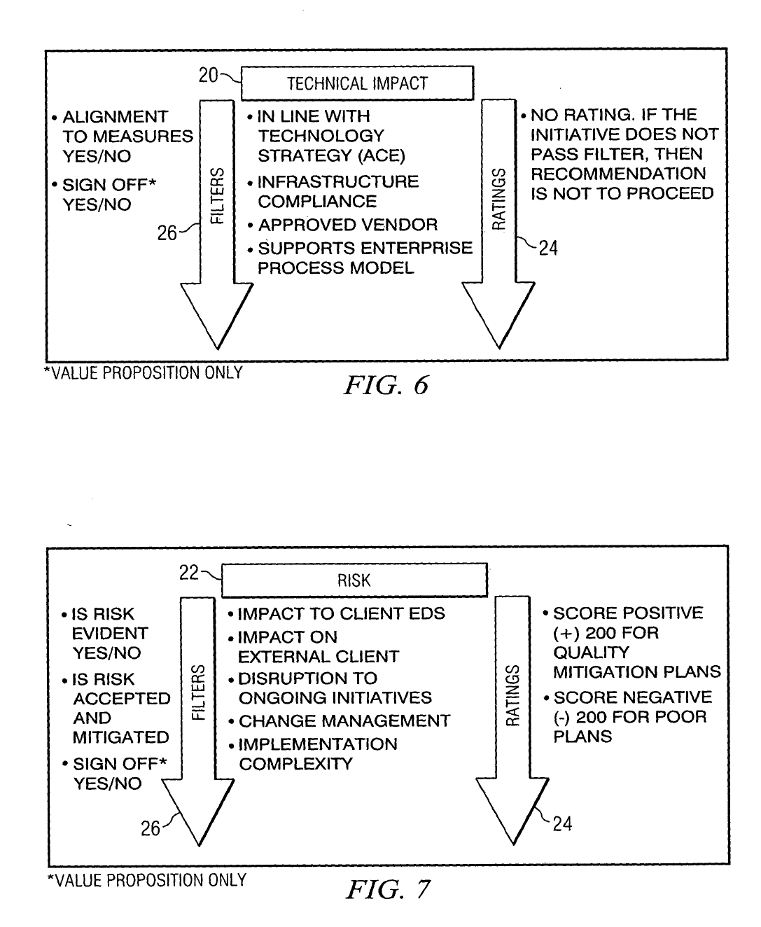

FIG. 6 is a simplified diagram of technical impact 20. Technical impact 20 can effectively wipe out all of the ratings 24 from the key categories if the initiative is not aligned to key technical directions. Factors that are considered include availability of leading technology, architectural compliance, use of prevailing technology, in line with technology strategy, infrastructure compliance, and approved vendors. At all phases of the initiative, sign off approval from a Delivery Architecture Information Technology (DAIT) board, a Global Architecture Information Council (GAIC), or another corporate governance entity is needed. Without approval, the initiative will not receive any strategic value rating.

FIG. 7 is a simplified diagram of risk impact 22. Risk impact 22 provides another override capability that can negate ratings from the key categories for the initiative. When making risk assessments, factors include impact to the business, impact to external clients, disruption to other initiatives, change in management, and implementation complexity. Well documented risk mitigation plans can assist an initiative when being rated. Poorly planned risks may have an adverse affect on the ratings for the initiative. In all phases of the initiative, portfolio management will perform appropriate checks and verify alignment with relevant parts of the appropriate corporate governance entity. As a result, recommendations can be made and the operating mechanism will acknowledge and sign off on the risks.

Filters 26 are applied to every key category discussed above. Filters may change, but are mainly simple yes/no toggle tests in answer to whether sign off has been achieved. Ratings 24 are applied to the key categories discussed above. Ratings may change and may include the application of weights for priority purposes. A report is produced for each initiative to show the current strategic value rating on strategic positioning 12, financial impact 14, intellectual assets 16, business drivers 18, technical impact 20, and risk impact 22. The report will also show how the ratings were applied in each category. A rating comparison can then be performed among initiatives where initiatives with higher rating scores may be pursued and implemented before initiatives with lower rating scores.

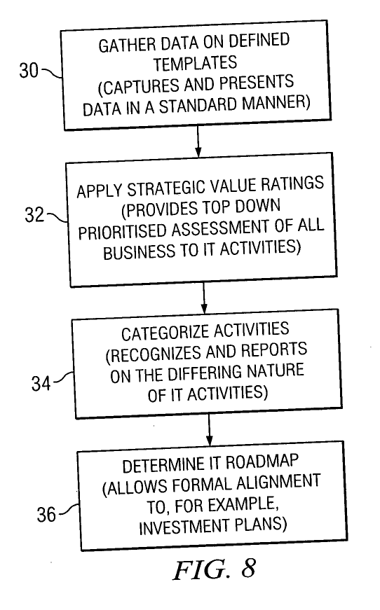

FIG. 8 shows a flow process supporting strategic value model 10. The flow process for strategic value model 10 includes four main tasks. The first task is to gather data 30. Data is gathered on defined templates for capture and presentation in a standard manner. The task of gathering data is associated with the various categories of strategic value model 10. Gathering data includes determining the alignment of a potential business initiative to key strategic positioning 12 such as corporate strategic agenda and specific business unit strategies. For internal initiatives, a corporate strategy and planning entity and the lines of business make this determination. For external initiatives, consultation and collaboration with the client is performed. The financial aspects 14 of the business initiative are assessed, such as NPV and payback, via the cost and benefit template. Essential non-financial aspects, or intellectual assets 16, are identified from the invisible balance sheet such as human capital, structural capital, and external capital. Business drivers 18 (which contain events such as alignment to investment plans, alignment to enterprise process models, sustainment of business, contractual agreements, legal commitments, and alignment with merger and acquisition targets) are captured and assessed. The technical impact 20 of the initiative (alignment with the technology strategy, compliance with infrastructure, use of approved vendors) is also assessed. Further, the risks 22 of the initiative are also considered.

The next task of the flow process for strategic value model 10 is applying strategic value ratings 32. The activities of the initiative are scored and weighted according to the key categories of strategic value model 10 by appropriate ratings 24. Filters 26 are also applied to document appropriate approval for an activity. TABLE I shows an example of the application of the ratings 24 in strategic value model 10.

TABLE I
Strategic Value Ratings

| Evaluation | | | |
|---|---|---|---|
| Criteria | Values | Scoring | Weight |
| Strategic | | | 20% |
| Positioning | | | |
| Corporate Level | | | |
| Alignment with | Accelerate top line | 100 points for | |
| key business | growth | each alignment | |
| strategies | Improve productivity | to the content | |
| | | contained in | |
| | | the value | |
| | | column | |
| Alignment with | Execute line of business | 100 points for | |
| strategic | strategies | each alignment | |
| agenda | Enhance market | to the content | |
| | effectiveness | contained in | |
| | Build innovation and | the value | |
| | thought leadership | column | |
| | Enhance people care and | | |
| | development | | |
| | Achieve service | | |
| | excellence and client | | |
| | loyalty | | |
| Alignment with | financial: | 100 points for | |
| goals and | Revenue growth - 9-11% | each alignment | |
| objectives | Improve operating | to the content | |
| | margin (mid-11%) | contained in | |
| | EPS growth > revenue | the value | |
| | growth - 17% | column | |
| | RONA > cost of capital - | | |
| | 10% | | |
| | Improve cash margin - | | |
| | 8% | | |
| | business: | | |
| | Grow Solutions | | |
| | Consulting | | |
| | Achieve Market | | |
| | Leadership in | | |
| | Business Process | | |
| | Outsourcing (BPO) | | |
| | Leverage brand - insights | | |
| | to operations | | |
| | Increase new Logo sales | | |
| | Increase pipeline, win- | | |
| | rate and velocity | | |
| | Offshore Delivery | | |
| | Strategy | | |
| | Continue Productivity | | |
| | Improvement | | |
| | Accelerate Digital | | |
| | Transformation | | |
| | Lead in Transformation | | |
| | Services | | |
| Alignment to | Digital Transformation | 100 points for | |
| strategic | Next Level | each alignment | |
| initiatives | Solutions Consulting | to the content | |
| | Transformation | contained in | |
| | | the value | |
| | | column | |
| Major Unit | | | |
| Level | | | |
| Alignment with | TBD | 50 points for | |
| Line of | | each alignment | |
| Business (LOB) | | to the content | |
| or Business | | contained in | |
| Support Unit | | the value | |
| (BSU) key | | column | |
| business | | | |
| strategies | | | |
| Alignment to | TBD | 50 points for | |
| growth | | each alignment | |
| strategies for | | to the content | |
| service lines | | contained in | |
| and offerings | | the value | |
| by region | | column | |
| IT Level | | | |
| Alignment to IT | TBD | TBD points for | |
| strategies and | Possible Examples: | each alignment | |
| plan | Legacy System | to the content | |
| | Decommissioning | contained in | |
| | Pre-requisite | the value | |
| | foundational element | column | |
| Financial | | | 25% |
| Impact | | | |
| Net Present | Negative or Zero | Negative or | |
| Value ($) to | Small <5 million | Zero = 0 | |
| the enterprise | Medium 5-10 million | Small - 100 | |
| | Large >10 million | Medium - 200 | |
| | | Large - 500 | |
| Payback Period | Short <18 months | Short - 150 | |
| | Medium 18-24 months | Medium - 100 | |
| | Long 24-48 months | Long - 50 | |
| | Too Long >48 | Too Long - 0 | |
| Capital | No capital | 150 | |
| | Small - TBD | 100 | |
| | Medium - TBD | 50 | |
| | Long - TBD | 0 | |
| Intellectual | | | 25% |
| Assets | | | |
| Intellectual | | | |
| Capital Balance | | | |
| Sheet | | | |
| Human Capital | TBD | 50 points for | |
| | Possible Examples: | each alignment | |
| | Employee Turnover | to the content | |
| | | contained in | |
| | | the value | |
| | | column if it | |
| | | can be | |
| | | measured | |
| Structural | TBD | 50 points for | |
| Capital | Possible Examples: | each alignment | |
| | Time to Market | to the content | |
| | | contained in | |
| | | the value | |
| | | column if it | |
| | | can be | |
| | | measured | |
| External | TBD | 50 points for | |
| Capital | Possible Examples: | each alignment | |
| | Client Satisfaction | to the content | |
| | | contained in | |
| | | the value | |
| | | column if it | |
| | | can be | |
| | | measured | |
| Patent | Yes or No | 50 points for | |
| Opportunity or | (taken from the pre- | each alignment | |
| Existing Patent | assessment process) | to the content | |
| | | contained in | |
| | | the value | |
| | | column if it | |
| | | can be | |
| | | measured | |
| Business | | | 20% |
| Drivers | | | |
| Sustaining | Risk/Impact is minimal | 200 | |
| Business | Risk/Impact is high | 1000 | |
| Contractual | Risk/Impact is minimal | 200 | |
| Agreement | Risk/Impact is high | 1000 | |
| Legal | Risk/Impact is minimal | 200 | |
| Commitment | Risk/Impact is high | 1000 | |
| Statutory or | Risk/Impact is minimal | 200 | |
| Regulatory | Risk/Impact is high | 1000 | |
| Requirement | | | |
| Alignment to | Risk/Impact is minimal | 200 | |
| merger/acquisition | Risk/Impact is high | 1000 | |
| Known audit | Risk/Impact is minimal | 200 | |
| exposure | Risk/Impact is high | 1000 | |
| Technical | | | 5% |
| Impact | | | |
| Global | Pass/Fail | No scoring | |
| Architecture | | (pass/fail) | |
| Information | | Pass = Global | |
| Council (GAIC) | | Process | |
| Sanctioned | | Leadership | |
| Strategy | | Council | |
| | | (GPLC) | |
| | | endorsement & | |
| | | prioritization | |
| | | can continue | |
| | | Fail = GPLC | |
| | | will not assess | |
| Approved Vendor | Pass/Fail | No scoring | |
| | | (pass/fail) | |
| | | Pass = GPLC | |
| | | endorsement & | |
| | | prioritization | |
| | | can continue | |
| | | Fail = GPLC | |
| | | will not assess | |
| Support | Pass/Fail | No scoring | |
| Enterprise | | (pass/fail) | |
| Integration | | Pass = GPLC | |
| Model | | endorsement & | |
| | | prioritization | |
| | | can continue | |
| | | Fail = GPLC | |
| | | will not assess | |
| Risk Impact | | | 5% |
| Impact to | None | None = 300 | |
| Client | Risk Low | Low = 200 | |
| | Risk Medium | Medium = 100 | |
| | Risk High | High = 0 | |
| Impact to | None | None = 300 | |
| external client | Risk Low | Low = 200 | |
| | Risk Medium | Medium = 100 | |
| | Risk High | High = 0 | |
| Management of | None | None = 300 | |
| Change (human | Risk Low | Low = 200 | |
| aspects) | Risk Medium | Medium = 100 | |
| | Risk High | High = 0 | |
| Audit | None | None = 300 | |
| exposure/risk | Risk Low | Low = 200 | |
| area | Risk Medium | Medium = 100 | |
| (potential) | Risk High | High = 0 | |
| Implementation | None | None = 300 | |
| complexity | Risk Low | Low = 200 | |
| Skills and | Risk Medium | Medium = 100 | |
| Competencies | Risk High | High = 0 | |
| Realistic | | | |
| ability to | | | |
| affect change | | | |
| Use of | | | |
| Prevailing | | | |
| Technology | | | |
| Mitigation | Yes or No | Yes = 50 | |
| Plan (s) | | No = 0 | |

Ratings 24 are applied to most strategic value categories and activities therein. A scoring system is applied to the categories with the total score for strategic positioning 12, financial impact 14, intellectual assets 16, and business drivers 18 being further rated against technical impact 20 and risk impact 22. The result yields a strategic value assessment that provides a determining factor of one initiative's value compared to another initiative. Filters 26 also affect the score for an initiative.

The third task in the flow process of strategic value model 10 is categorizing activities 34. Initiatives are categorized and reported so that like initiatives can be assessed against each other. Initiative categories include those that transform the business, grow the business, gain a competitive advantage, and require technology refresh.

The fourth task in the flow process of strategic value model 10 is determining the roadmap 36. A definitive list is compiled of all initiatives in the pipeline awaiting approval, in an active state, and in a suspended state. The ratings 24 from strategic value model 10 are used to support decisions for each initiative in the pipeline. This information is held in a software application that provides a complete enterprise view of the business and its technical environment and allows for quick assessment of any changes. The software application provides for the input of data gathered in task 30, the strategic value application in task 32, the categorizing performed in task 36, with the result being the core for the roadmap of task 36. The software application may be implemented as one or more software modules operating on one or more computing platforms.

In summary, the strategic value model provides a formal business decision tool which allows internal operating mechanisms, or business governance, and external clients to make fact based judgments, recommendations, and decisions regarding the support of certain business and information technology initiatives. The strategic value model enables the collection and assessment of accurate and timely data supported by key business leaders. With this information, business leaders can determine whether to release, redirect, or deny funding based on a comprehensive examination of facts over and above those of a purely financial nature. As a result, these informed decisions will translate into value for the business through proper alignment of information technology to the business in order to deliver additional cost savings and benefit realization.

Thus, it is apparent that there has been provided, in accordance with the present invention, a method of assessing information technology in a business that satisfies the advantages presented above. Although the present invention has been described in detail, it should be understood that various changes, substitutions, and alterations may be readily ascertainable by those skilled in the art and may be made herein without departing from the spirit and scope of the present invention as defined by the following claims. Moreover, the present invention is not intended to be limited in any way by any statement made herein that is not otherwise reflected in the following claims.

1. A method of assessing information technology needs in a business, comprising:
gathering information associated with the operation of the business in categories pertaining to the information technology initiative desired to be implemented;
applying strategic value ratings to each criteria in the categories;
categorizing initiatives so that like initiatives are assessed against each other;
determining which initiatives are to be funded in accordance with the applied strategic value ratings.

2. The method of claim 1, further comprising:
applying an approval filter to each criteria of the categories.

3. The method of claim 2, further comprising:
applying the strategic value rating in response to an affirmative approval filter.

4. The method of claim 1, further comprising:
calculating a strategic value assessment for each initiative from the strategic value ratings.

5. The method of claim 4, further comprising:
establishing funding for an initiative with the highest strategic value assessment.

6. The method of claim 4, further comprising:
comparing the strategic value assessment of a first initiative to strategic value assessment of a second initiative;
prioritizing the first initiative with respect to the second initiative in response to the strategic value assessment comparison.

7. The method of claim 1, further comprising:
applying a weight factor to each category pertaining to the initiative.

8. The method of claim 1, wherein the categories include strategic positioning, financial impact, intellectual assets, and business drivers associated with the business.

9. The method of claim 1, wherein technical impact and risk impact overlays affect the application of the strategic value ratings.

10. The method of claim 1, wherein the initiatives are categorized according to whether an initiative transforms the business, grows the business, provides a technological advantage, and involves a technology refresh.

11. A computer readable medium including code for assessing information technology needs in a business, the code operable to:
receive information associated with the operation of the business in categories pertaining to the information technology initiative desired to be implemented;
apply strategic value ratings to each criteria in the categories;
categorize initiatives so that like initiatives are assessed against each other;
determine which initiatives are to be funded in accordance with the applied strategic value ratings.

12. The computer readable medium of claim 11 wherein the code is further operable to:
apply an approval filter to each criteria of the categories.

13. The computer readable medium of claim 11, wherein the code is further operable to:
apply a weight factor to each category pertaining to the initiative.

14. The computer readable medium of claim 11, wherein the code is further operable to:
calculate a strategic value assessment for each initiative from the strategic value ratings.

15. The computer readable medium of claim 14, wherein the code is further operable to:
compare the strategic value assessment of a first initiative to strategic value assessment of a second initiative;
prioritize the first initiative with respect to the second initiative in response to the strategic value assessment comparison.

16. A system for assessing information technology needs in a business, comprising:
means for receiving information associated with the operation of the business in categories pertaining to the information technology initiative desired to be implemented;
means for applying strategic value ratings to each criteria in the categories;
means for categorizing initiatives so that like initiatives are assessed against each other;
means for determining which initiatives are to be funded in accordance with the applied strategic value ratings.

17. The system of claim 16, further comprising:
means for applying an approval filter to each criteria of the categories.

18. The system of claim 16, further comprising:
means for applying a weight factor to each category pertaining to the initiative.

19. The system of claim 16, further comprising:
means for calculating a strategic value assessment for each initiative from the strategic value ratings.

20. The system of claim 19, further comprising:
means for comparing the strategic value assessment of a first initiative to strategic value assessment of a second initiative;
means for prioritizing the first initiative with respect to the second initiative in response to the strategic value assessment comparison.
